(19) United States
(12) Patent Application Publication
(10) Pub. No.: US 2011/0157666 A1
(43) Pub. Date: Jun. 30, 2011

(54) Image reading apparatus

(75) Inventors: Hiroyuki Hirokawa, Koshu-shi (JP); Yutaka Akaike, Nishiyatsushiro-gun (JP); Shinnosuke Enomoto, Minamialps-shi (JP)

(73) Assignee: NISCA CORPORATION, Minamikoma-gun (JP)

(21) Appl. No.: 12/926,781

(22) Filed: Dec. 9, 2010

(30) Foreign Application Priority Data
Dec. 25, 2009 (JP) 2009-294882

(51) Int. Cl. H04N 1/04

(52) U.S. Cl. 358/498; 358/474

(57) ABSTRACT

To enable accurate image reading and concurrently therewith, enable a reading optical system to be varied easily in an apparatus configuration in which first and second read portions are disposed in planes inclined a predetermined angle, the apparatus has an apparatus housing 10, a platen 11 disposed in the apparatus housing to form the first read portion 11a and the second read portion 11b in planes mutually inclined a predetermined angle, a reading carriage 12, 40 disposed to be able to shift to positions between the first read portion and the second read portion, and a light source lamp 15, 41 for applying light to a document sheet on the platen, and a reflecting mirror 16, 42 for guiding the reflected light from the document sheet toward image reading means 13 each mounted on the reading carriage, and is configured so that an angular attitude of the reflecting mirror 16 is deflected by a predetermined angle or deflecting means 46 disposed in the second read portion guides the reflected light to the reflecting mirror 42 when the reading carriage is positioned in the second read portion.

### BACKGROUND OF THE INVENTION

1. Technical Field

The present invention relates to an image reading apparatus for reading an original document used in a scanner apparatus, copier, facsimile, etc., and more particularly, to improvements in the reading mechanism provided with a read portion of the mounted and set original document, and another read portion for reading an original document moving at a predetermined velocity.

2. Description of the Related Art

Generally, the scanner apparatus for reading an original document is widely known, for example, as an input apparatus of a computer system, or a document reading apparatus of a copier, facsimile, and the like. Then, as the structure, such an apparatus is known that the image of an original document sheet set on a platen is read in line sequence by an optical carriage traveling along the platen.

As this type of scanner apparatus, for example, as disclosed in Japanese Patent Gazette No. 4294655, such an apparatus is known that an optical unit (hereinafter, referred to as an “optical carriage”) reciprocating along the platen is provided, a light source lamp is provided in the optical unit, the reflected light of the light from the light source is changed to the predetermined direction by mirrors, and guided to an optical sensor by a condenser lens, and that an electrical signal subjected to photoelectric conversion by the optical sensor is electrically processed (for example, digitalized) and output.

Japanese Patent Gazette No. 4294655 discloses an apparatus in which an image reading platen has a read portion (first platen) for setting a resting original document, and another read portion (second platen) for reading a moving original document traveling at a predetermined velocity, a feeder unit is provided above the platen, document sheets are fed from a paper feed tray of the unit to the second platen, and the image-read document sheets are stored in a sheet discharge tray.

In such a conventional case where the first and second read portions are provided in the image reading platen, and one of the portions is formed of a flatbed platen, while the other one is formed of an exposure platen, as described in Japanese Patent Gazette No. 4294655, the first read portion and the second read portion are formed in the same plane. This is because of sharing a reading carriage to read the image, shifting the position of the carriage horizontally, and thereby reading the image in the first and second read portions.

Then, with respect to two, first and second, read portions, there are known a case where the first read portion is formed at one end of a single sheet of flat glass, while the second read portion is formed at the other end, and another case where both read portions are formed of respective different glass plates.

As described above, in the image reading apparatus provided with two, first and second, read portions, it has conventionally been configured that two read portions are formed in the same plane, and that the reading carriage travels in parallel along the plane. Therefore, it is configured that the slit exposure platen for reading a moving document sheet is in the same plane as that of the flatbed platen on which a resting document sheet is set, the feeder unit disposed above the platen feeds a document sheet from a tray disposed above the platen to the read portion, and that the sheet is picked upward from the read portion and stored in the tray.

Therefore, in the feeder unit, it is forced to form a document transport path using a curved path, for example, in the shape of a U. In such a curved path, particular sheets such as thick document sheets and coating sheets result in transport failure due to transport loads. However, recently, gross paper such as a color document with the surface coated, or thick sheets for front-cover sheets have been used with frequency, and problems occur frequently that transport fluctuations occur in feeding by the feeder unit and that the document sheet sustains damage.

Then, the inventor of the invention arrived at findings that by inclining the slit exposure platen a predetermined angle with respect to the flatbed platen, it is possible to configure the transport path of the feeder unit situated above in a linear straight path. In this case, the need for varying the reading optical system arises so as to read the image of both of the platens using the common reading carriage.

It is a principal object of the invention to provide an image reading apparatus for enabling accurate image reading and concurrently therewith, enabling a reading optical system to be varied easily in an apparatus configuration in which first and second read portions are disposed in planes inclined a predetermined angle.

### BRIEF SUMMARY OF THE INVENTION

To attain the above-mentioned object, in the invention, a first read portion and second read portion are disposed in planes inclined a predetermined angle in an apparatus housing, a reading carriage shifting to positions between both of the read portions is mounted with a light source lamp and reflecting mirrors for guiding the reflected light from a document sheet toward an image reading means. Then, the invention is characterized in that when the carriage is positioned in the second read portion, the angular attitude of the reflecting mirror is deflected by a predetermined angle or the reflected light from a document sheet is guided to the reflecting mirror using a deflecting means disposed in the second read portion. By this means, it is neither necessary to provide each of the first and second read portions with an image reading unit, nor necessary to change the angle of the entire image reading unit, and it is thereby possible to perform image reading with accuracy in simplified structure.

The configuration will be described specifically. The apparatus has a first read portion (11a) on which a document sheet is mounted, and a second read portion (11b) inclined a predetermined angle with respect to the first read portion for a document sheet to move, is provided with an apparatus housing (10), a platen (11) disposed in the apparatus housing to form the first read portion and the second read portion in planes mutually inclined a predetermined angle, a reading carriage (12, 40) disposed to be able to shift to positions between the first read portion and the second read portion, and a light source lamp (15, 41) for applying light to a document sheet on the platen, and a reflecting mirror (16, 42) for guiding the reflected light from the document sheet toward an image reading means (13, 44) each mounted on the reading carriage, and is configured so that an angular attitude of the reflecting mirror (16) is deflected by a predetermined angle or a deflecting means (46) disposed in the second read portion guides the reflected light to the reflecting mirror (42) when the reading carriage is positioned in the second read portion.

### EFFECT OF THE INVENTION

The invention provides that a first read portion and second read portion are disposed in planes inclined a predetermined angle in an apparatus housing, a reading carriage shifting to positions between both of the read portions is mounted with a light source lamp and reflecting mirrors, and that when the reading carriage is positioned in the second read portion, the angular attitude of the reflecting mirror is deflected by a predetermined angle or the deflecting means disposed in the second read portion guides the reflected light from a document sheet to the reflecting mirror, and therefore, has the effects as described below.

Since the first and second read portions are disposed in the planes inclined a predetermined angle, as compared with the case where the portions are disposed in the same plane, it is possible to design the path shape flexibility so as to configure the transport path of the feeder unit for feeding a document sheet to the second read portion in a linear straight path, for example.

Concurrently therewith, by shifting the reading carriage to positions between the first and second read portions, it is made possible to read the image in both of the read portions. Therefore, the need is eliminated for providing both of the read portions with respective reading units, and it is possible to make the apparatus small and compact.

Further, the invention is configured to deflect the angular attitude of the reflecting mirror arranged in the reading carriage by a predetermined angle, thereby eliminates the need for deflecting the angular attitude of the entire reading carriage, and thus enables images of two different read portions to be read in simplified structure. Accordingly, for example, the unit frame of the reading carriage is supported to be able to reciprocate along the first read portion, the second read portion is disposed on the extension, and it is thereby possible to shift the reading carriage to positions accurately in a stable state, and obtain accurate image reading.

Furthermore, the invention is configured so that the deflecting means such as a mirror is provided in the second read portion, and guides the reflected light from the document sheet moving in the second read portion to the reflecting mirror disposed in the reading carriage, and thereby enables the reading optical system to adapt to different reading positions by shifting the reading carriage to positions without providing a particular shift means and driving means thereof.

### BRIEF DESCRIPTION OF THE SEVERAL VIEWS OF THE DRAWINGS

FIG. 1 is an explanatory view of the entire configuration of an image reading apparatus and document feeding apparatus according to the invention;

FIG. 2 contains detailed explanatory diagrams of an image reading section in the apparatus shown in FIG. 1, where FIG. 2(a) shows a configuration of a reading carriage, and FIG. 2(b) is an explanatory view of an angle deflecting mechanism of a reflecting mirror;

FIG. 3 shows Embodiment 1 of the reading carriage, where FIG. 3(a) is an explanatory view when the carriage is positioned in a first read portion, and FIG. 3(b) is an explanatory view when the carriage is positioned in a second read portion; and

FIG. 4 shows Embodiment 2 of the reading carriage, where FIG. 4(a) is an explanatory view when the carriage is positioned in the first read portion, and FIG. 4(b) is an explanatory view when the carriage is positioned in the second read portion.

### DETAILED DESCRIPTION OF THE INVENTION

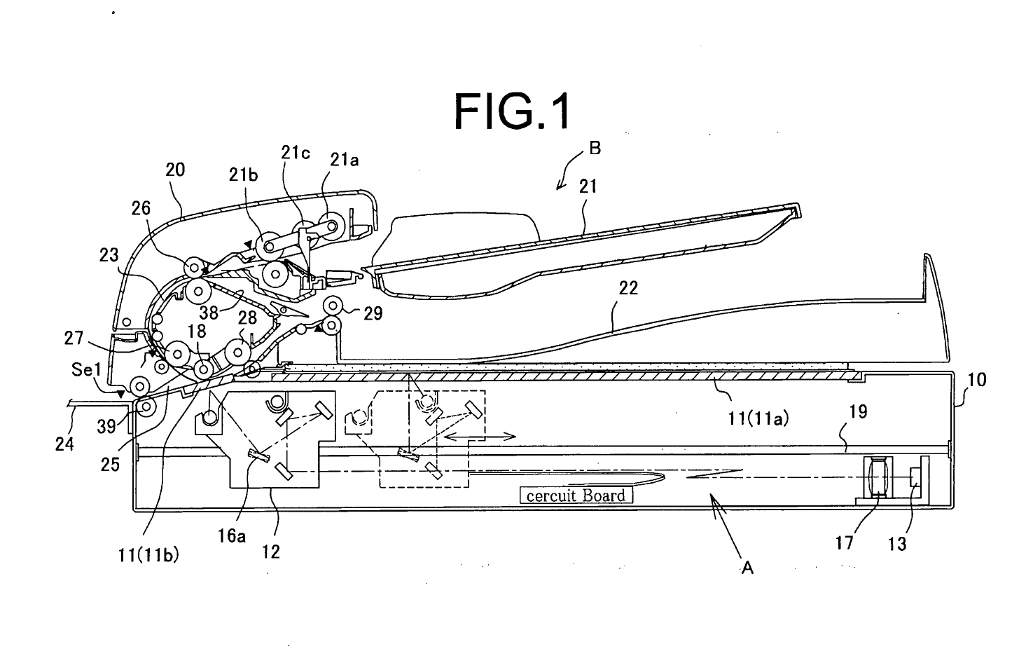

The apparatus as shown in FIG. 1 is comprised of an image reading apparatus (scanner unit) A and a document feeding apparatus (feeder unit) B installed in the apparatus A. The image reading apparatus A is comprised of an apparatus housing 10, platen 11 installed in the housing 10, reading carriage 12, and image reading means 13. The apparatus as shown in FIG. 1 is further comprised of a housing 20 of the document feeding apparatus B, and a paper feed tray 21, sheet discharge tray 22 and document feed path (U-shaped curved path) 23 installed in the housing 20, and is concurrently provided with a manual tray 24 to mutually feed particular document sheets, and a document feed path (straight path) 25. Each configuration will specifically be described below.

### [Configuration of the Image Reading Apparatus]

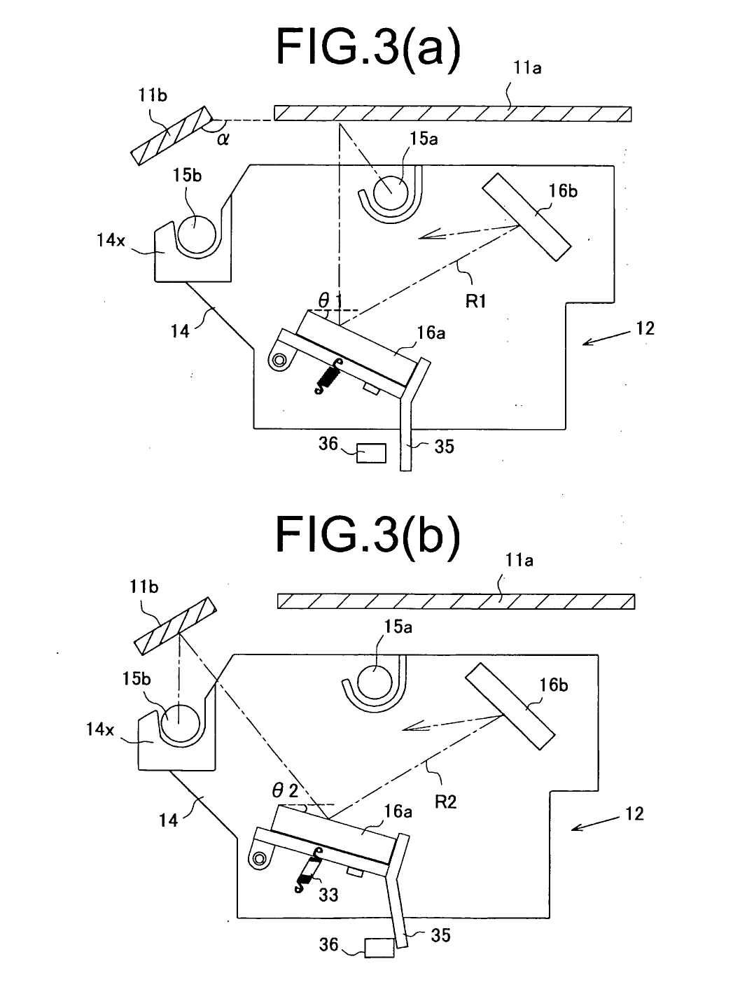

In the image reading apparatus A, the apparatus housing 10 is formed in an appropriate shape by molding of synthetic resin, etc. An external case forming the housing is provided with a first read portion 11a comprised of platen glass, and a second read portion 11b inclined a predetermined angle α (shown in FIG. 3) with respect to the first read portion 11a. The first and second read portions 11a, 11b constitute the platen 11, and may be formed of two different sheets of plate glass as shown in the figure or may be comprised of a single sheet of plate glass (curved plate glass).

The above-mentioned platen 11 is comprised of a flat platen (flatbed platen structure; the same in the following) to mount and set a document sheet on the first read portion 11a to read, and a slit platen (slit exposure platen structure; the same in the following) to read a moving document sheet traveling at a predetermined velocity in the second read portion 11b.

Then, as described above, the second read portion 11b is inclined an angle α (0 degree □α□90 degrees) with respect to the first read portion 11a. As the reason, a document press cover, positioning scale and the like of the flatbed platen 11a become obstructions in feeding and discharging a document sheet to/from the slit platen 11b when both of the read portions are in the same plane, and to avoid such obstructions, a document sheet should be fed and discharged using a U-shaped curved path.

Therefore, by inclining the slit platen 11b a predetermined angle, it is intended to transport a document sheet in a linear straight path from above to below the flat platen 11a or from below to above. By this means, it is possible to automatically read a document sheet such as a thick sheet and coating sheet easy to undergo a roller mark.

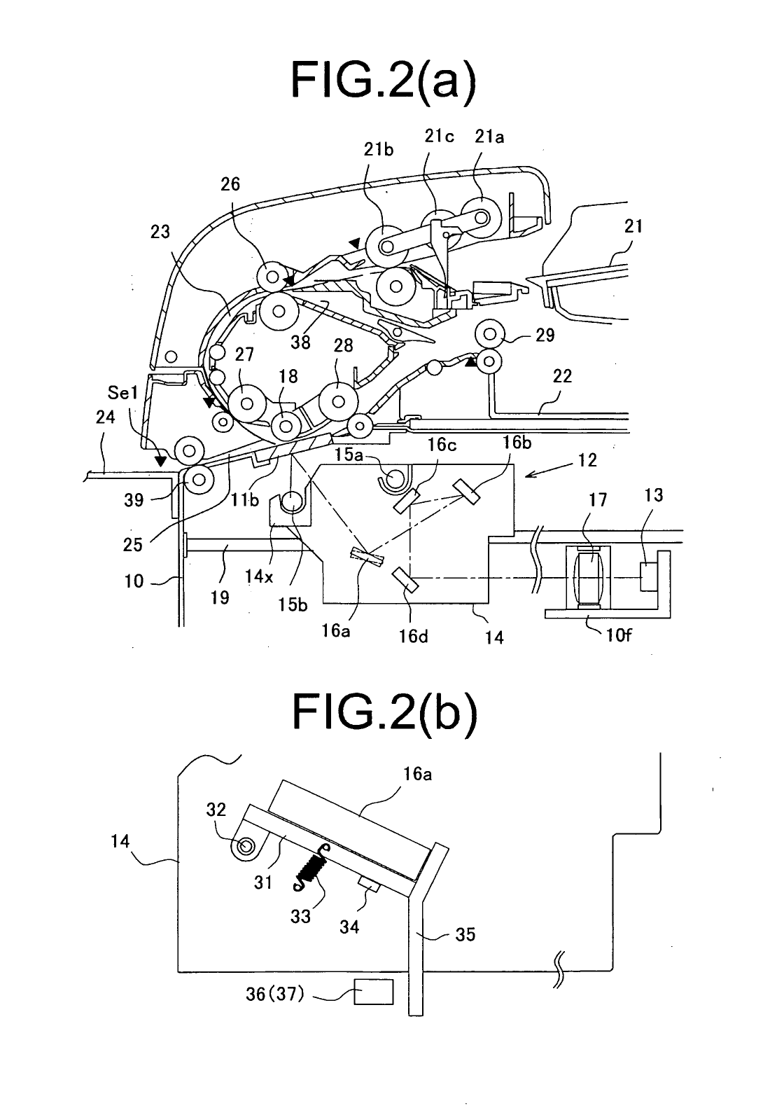

As the reading carriage 12, various configurations are known, and the invention is capable of adopting any of the configurations. As the first carriage structure, as shown in FIG. 2, a light source lamp 15 and reflecting mirrors 16 are incorporated into a carriage frame 14, and a condenser lens 17 and image reading means 13 are mounted on an apparatus frame (such as chassis) 10f.

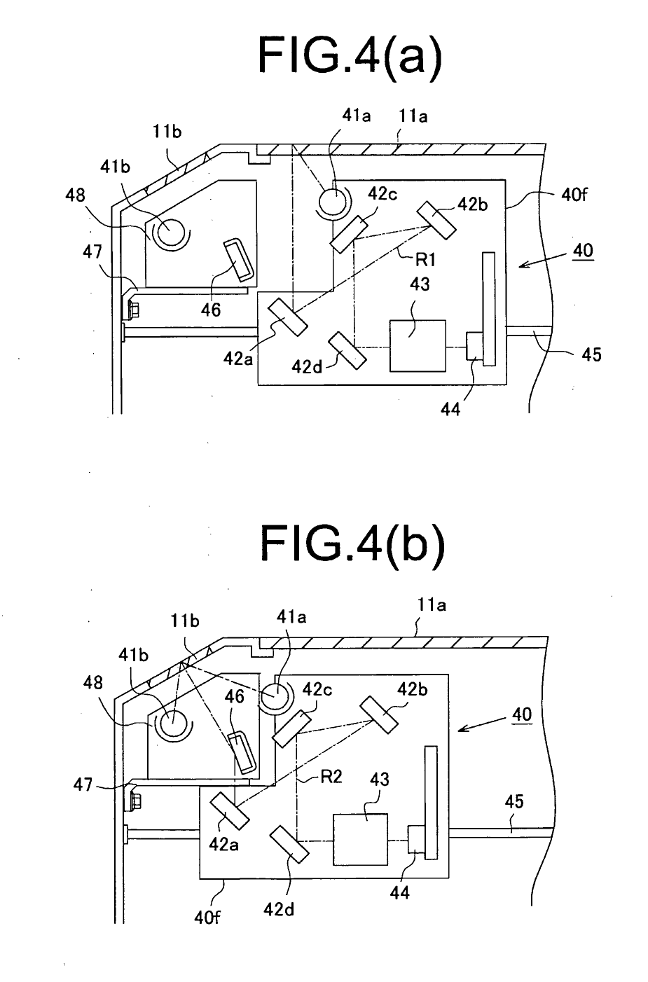

As shown in FIG. 4 described later, in the second carriage structure, into a carriage frame 40f are incorporated light source lamps 41a, 41b, reflecting mirrors 42 (first mirror 42a, second mirror 42b, third mirror 42c and fourth mirror 42d), condenser lens 43 and photoelectric conversion sensor (reading sensor; image reading means) 44.

Thus, as the reading carriage 12, it is possible to adopt both of the structures that the light source lamp 15 and reflecting mirrors 16 (at least one) are incorporated into the carriage frame 14 and that the light source lamps 41a, 41b, reflecting mirrors 42, condenser lens 43, and photoelectric conversion sensor (reading sensor) 44 are incorporated into the carriage frame 40f.

The light source lamp 15 is fixed to a lamp storage portion 14x of the carriage frame 14 formed of a heat resistant resin. The light source lamp 15 is capable of adopting any of configurations such as a fluorescent tube (CCFL), LED lamp, and Xenon lamp that are rod-shaped emitters. Further, the reflecting mirror 16 is capable of adopting any of configurations such as a plate-shaped glass mirror and prism that change the direction of light from a predetermined direction toward the reading sensor (image reading means) 13.

The reading carriage 12 configured as described above is attached to the apparatus housing 10 to be able to reciprocate along the first read portion (flat platen) 11a. In the apparatus as shown in the figure, as shown in FIG. 1, a pair of right and left parallel guide rails 19 are disposed in the apparatus housing 10, and the carriage frame 14 is bearing-supported by the guide rails (that are rods in the apparatus as shown in the FIG. 19.

Accordingly, the reading carriage 12 is supported to be able to reciprocate along the flat platen (first read portion) 11a in the horizontal direction in FIG. 1. Then, not shown in the figure, a pair of pulleys are disposed in the apparatus housing 10, pulling members such as timing belts and wire are looped between the pulleys, and one of the pulleys is coupled to a carriage motor. By rotating the carriage motor forward and backward, the reading carriage 12 reciprocates in the horizontal direction in FIG. 1.

Therefore, in the invention, the reading carriage 12 is configured to be able to shift to positions between the first read portion 11a and second read portion 11b. The configuration is to extend the guide rails 19 to enable the shift between both of the read portions. Then, the invention is characterized in that reading is varied as described below when the carriage 12 is positioned in the first read portion 11a, and in the second read portion 11b.

The first method is a mechanism in which the angular attitude of the reflecting mirror 16 mounted on the reading carriage 12 is deflected by a predetermined angle, and the second method is a mechanism in which a deflecting means 46 is provided in the second read portion 11b, and guides the reflected light from a document sheet moving in the second read portion 11b to the reflecting mirror 16 of the carriage 12. The first method and the second method will be described below respectively as Embodiment 1 and Embodiment 2.

### Embodiment 1

As shown in FIGS. 2 and 3, in the reading carriage 12, a read optical path R1 is formed including the first mirror 16a that deflects toward a document sheet on the first read portion 11a, the second mirror 16b that reflects the light from the reflecting mirror 16a, third mirror 16c and fourth mirror 16d in this order, and it is configured that the light from the fourth mirror 16d is guided to the condenser lens 17 and that image formation is made in the reading sensor (image reading means) 13 using the lens 17.

Then, one (the first mirror 16a in the apparatus as shown in the figure) of the mirrors constituting the reflecting mirrors 16 is configured to be rotatable so that the angular attitude is deflected by a predetermined angle. In the apparatus as shown in the figure, as shown in FIG. 2(b), a bracket 31 of the first mirror 16a is axially supported in a spindle 32 rotatably by the carriage frame 14. Then, a biasing spring (biasing means) 33 is held between the bracket 31 and the carriage frame 14 so as to rotate the reflecting mirror 16a in a clockwise direction in the figure.

The carriage frame 14 is provided with a regulation stopper 34, the first mirror 16a is positioned in the regulation stopper 34 by the action of the biasing spring 33, and the angular attitude of the mirror 16a is kept at a first angle position (θ1). FIG. 3(a) shows this state, and the first mirror 16a is held in the first angle position (θ1), and forms the read optical path R1 for guiding the reflected light from a document sheet on the first read portion 11a to the reading sensor (image reading means) 13.

The bracket 31 is provided with a cam lever 35 integrally formed therein, and the cam lever 35 engages in a regulation member 36 disposed in the second read portion 11b of the apparatus frame 10f, and changes the angular attitude of the first mirror 16a to the state of FIG. 3(b) i.e. second angle position (θ2). Then, in this state, the first mirror 16a forms a read optical path R2 for guiding the reflected light from a moving document sheet traveling in the second read portion 11b to the reading sensor (image reading means) 13.

Accordingly, a shifting means 37 for varying the angular attitude of the rotatable reflecting mirror (first mirror) 16a from the first angle position (θ1) to the second angle position (θ2) is comprised of the regulation member 36 and carriage motor (not shown) for shifting the reading carriage 12 from the first read portion 11a to the second read portion 11b.

In such a configuration, when the reading carriage 12 is shifted from the first read portion 11a to the second read portion 11b, the regulation member 36 changes the attitude of the first reflecting mirror (first mirror) 16a from the first angle position (θ1) to the second angle position (θ2), and on the other hand, when the reading carriage 12 is shifted from the second read portion 11b to the first read portion 11a, changes the attitude of the first reflecting mirror (first mirror) 16a from the second angle position (θ2) to the first angle position (θ1).

In the Embodiment as shown in the figure, the first light source lamp 15a and the second light source lamp 15b are mounted on the carriage frame 14. Then, when a document sheet on the first read portion 11a is read, the first light source lamp 15a is lighted, and the second light source lamp 15b is turned off. Meanwhile, when a document sheet on the second read portion 11b is read, the first and second light source lamps 15a, 15b are both lighted.

This is because of adjusting the light amount in the (high-speed reading) relation to the moving velocity of a document sheet traveling through the second read portion 11b that is made faster than the traveling velocity of the reading carriage 12 shifting along the first read portion 11a. In addition, the distance between the first read portion 11a and the reflecting mirror (first mirror) 16a and the distance between the second read portion 11b and the reflecting mirror (first mirror) 16a are set so that the optical lengths are the same lengths as one another.

### Embodiment 2

FIG. 4 shows Embodiment 2, and as described previously, the reading carriage 40 shown in the figure has the light source lamp 41a, reflecting mirrors 42 condenser lens 43, and reading sensor (image reading means) 44 incorporated into the carriage 40f, and is configured to be able to shift to positions between the first read portion 11a and second read portion 11b using the carriage frame 40f by a pair of right and left parallel guide rails 45.

Therefore, in the Embodiment shown in the figure, the deflecting means 46 is disposed which guides the reflected light from a document sheet moving along the second read portion 11b to the reflecting mirror 42 mounted on the carriage frame 40f. In the apparatus housing 10, a bracket 47 is provided in the second read portion 11b, and the deflecting means 46 is fixed to the bracket 47.

The deflecting means 46 uses an element such as a mirror, prism and optical fiber that deflects the light in a predetermined direction to guide. Then, the deflecting means 46 is set for the position relationship that the means 46 guides the reflected light from a document sheet to the reflecting mirror (the first mirror 42a in the apparatus as shown in the figure) mounted on the reading carriage 40 when the reading carriage 40 as shown in FIG. 4(b) is positioned in the second read portion 11b.

To the bracket 47 shown in the figure is attached a unit frame 48 mounted with the deflecting means 46 and second light source lamp 41b, and the bracket 47 is fixed to the side wall of the apparatus housing 10. Then, the second light source lamp 41b applies light to a document sheet moving on the second read portion 11b, and it is configured that the reflected light is guided to the first mirror 42a of the reading carriage 40.

Accordingly, when the reading carriage 40 is positioned in the first read portion 11a by the carriage motor not shown, as shown in FIG. 4(a), the light source lamp 41a applies the light to a document sheet on the first read portion 11a, and the read optical path R1 is constructed so that the reflected light forms an optical path from the first mirror 42a to the fourth mirror 42d and that the light from the fourth mirror 42d is condensed onto the reading sensor (image reading means) 44 for image formation by the condenser lens 43. Then, the reading carriage 40 reads the image along the document sheet set in the first read portion 11a while shifting from one end to the other end by the carriage motor (not shown).

Then, when the reading carriage 40 is shifted in position from the first read portion 11a to the second read portion 11b by controlling rotation of the carriage motor, as shown in FIG. 4(b), the first light source lamp 41a and second light source lamp 41b apply the light to the document sheet on the second read portion 11b, the reflected light is guided to the first mirror 42a mounted on the reading carriage 40 by the deflecting means 46, and the read optical path R2 is constructed so that the light is guided to the condenser lens 43 via from the first mirror 42a to the fourth mirror 42d and condensed onto the reading sensor (image reading means) 44 for image formation. In addition, in the apparatus as shown in FIG. 4, a focusing mechanism (not shown) is incorporated into the condenser lens 43, and the position is modified corresponding to the optical lengths L1 and L2 of the read optical paths.

### [Configuration of the Light Source Lamp]

The configuration of the light source lamp will be described in Embodiments 1 and 2 as described above. The light source lamp 15 (41) is comprised of rod-shaped emitters (fluorescent tube (CCFL), Xenon, LED, etc.). The light source lamp 15 (41) is not necessarily comprised of two lamps as shown in the figure, and may be comprised of one or three or more lamps. In this case, in the feeder unit B as described later, the velocity of a document sheet traveling in the second read portion 11b is made faster than the velocity of the reading carriage 12 (40) shifting along the first read portion 11a.

In other words, the reading speed in the second read portion 11b is made faster than the reading speed in the first read portion 11a. Therefore, the light amount to apply to a document sheet is preferably higher in the second read portion 11b than in the first read portion 11a.

It is possible to make such light amount adjustments by adopting either of the following methods.

(1) Adjusted is the level of power to supply to the light source lamp 15 (41) mounted on the reading carriage 12 (40). For example, a switching means for supply power or supply current is provided in a power supply circuit for supplying power to the light source, and a light amount adjusting means is provided to adjust the level of power to supply to the lamp. The light amount adjusting means is widely known as PWM control, and specific descriptions thereof are omitted.

(2) Provided is a light amount adjusting means for selectively lighting at least two, first and second, light source lamps 15 (41) mounted on the reading carriage 12 (40). In Embodiment 1 as described previously, the first light source lamp 15a and second light source lamp 15b are mounted on the reading carriage 12, and the first light source lamp 15a is arranged in the position for applying light to a document sheet on the first read portion 11a, while the second light source lamp 15b is arranged in the position for applying light to a document sheet on the second read portion 11b. Then, it is configured that the emission amount of the second light source lamp 15b is greater than the emission amount of the first light source lamp 15a.

In such a configuration, the first light source lamp 15a is lighted when the reading carriage 12 is positioned in the first read portion 11a, and the second light source lamp 15b is lighted when the reading carriage 12 is positioned in the second read portion 11b. By this means, it is possible to adjust the light amount to apply to a document sheet, and a switching circuit for turning “ON” and “OFF” the supply power constitutes the light amount adjusting means.

(3) A light amount adjusting means is provided to light at least two, first and second light, source lamps at the same time, or light one of the lamps. In Embodiment 2 as described previously, the first light source lamp 41a is disposed in the reading carriage 40, and the second light source lamp 41b is disposed in the unit frame 48. Then, the first light source lamp 41a is arranged in the position enabling the lamp 41a to apply the light to a document sheet on the first read portion 11a, and concurrently therewith, apply the light to a document sheet on the second read portion 11b.

Then, when the reading carriage 40 is positioned in the first read portion 11a, the power is supplied to the first light source lamp 41a. When the reading carriage 40 is positioned in the second read portion 11b, the power is supplied to the first light source lamp 11a, while being concurrently supplied to the second light source lamp 41b. By this means, it is possible to adjust the light amount, and the switching circuit for turning the supply power “ON” and “OFF” constitutes the light amount adjusting means.

### [Image Reading Means]

The image reading sensor 13 (44) is comprised of a photoelectric conversion sensor such as a CCD, and performs photoelectric conversion on the reflected light of the document sheet sent from the condenser lens 17 (43). Particularly, the image reading sensor 13 (44) shown in the figure is comprised of a color line sensor in which sensor elements constituting respective pixels of R (Red), G (Green) and B (Blue) are arranged in three lines. The image reading sensor 13 (44) with such a configuration is attached to a board, and the board is fixed to the carriage frame 14 (40f) or chassis (apparatus frame). Then, the document sheet on the first or second read portion 11a, 11b is read in line sequence, and the electronic data is subjected to image processing, and then transferred to the outside apparatus.

### [Configuration of the Document Feeding Apparatus]

As shown in FIG. 1, the document feeding apparatus (feeder unit; the same in the following) B is disposed above the first read portion 11a to cover the portion 11a, and automatically feeds document sheets to the second read portion 11b. Therefore, the paper feed tray 21 to mount document sheets and the sheet discharge tray to store the document sheets from the read portion are arranged vertically above the first read portion 11a.

A curved feed path 23 for feeding a document sheet at a predetermined velocity via the second read portion 11b is provided in between the paper feed tray 21 and the sheet discharge tray 22, and this path is formed of a path substantially in the shape of a U as shown in the figure. In the curved feed path 23 are disposed a register roller pair 26, lead roller 27, carrying-out roller 28 and sheet discharge roller 29 in this order from the upstream side.

Then, a backup roller 18 is disposed in the second read portion 11b as a driven roller. Further, a pickup roller 21a and paper feed roller 21b are disposed in the paper feed tray 21, and a separation roller 21c is disposed in the paper feed roller 21b. “38” shown in the figure denotes a circulating path and is a path for two-sided reading for switching back a document sheet of which the front side is read in the second read portion 11b and transporting the back side again to the second read portion 11b.

The paper feeding apparatus B is provided with the manual tray 24, and the manual tray 24 is disposed above or below the second read portion 11b to constitute a substantially linear path. The tray 24 shown in the figure is disposed below the second read portion 11b, and in the entrance of the tray 24 are disposed a carry-in roller pair 39 and document sensor Se1. Then, the manual tray 24 and the sheet discharge tray 22 are provided with a straight feed path 25 for feeding a document sheet in a linear path. The carry-in roller pair 39 is driven by a driving motor (not shown) when a document sheet is prepared along the manual tray 24 and is detected by the document sensor Se1, and the document sheet is shifted to the second read portion 11b. Then, the document sheet is shifted to the sheet discharge tray 22 by the carrying-out roller 28 and sheet discharge roller 29.

In addition, this application claims priority from Japanese Patent Application No. 2009-294882 incorporated herein by reference.

What is claimed is:

1. An image reading apparatus having a first read portion on which a document sheet is mounted, and a second read portion inclined a predetermined angle with respect to the first read portion for a document sheet to move, comprising:
an apparatus housing;
a platen disposed in the apparatus housing to form the first read portion and the second read portion;
a reading carriage disposed to be able to shift to positions between the first read portion and the second read portion; and
a light source lamp for applying light to a document sheet on the platen, and a reflecting mirror for guiding the reflected light from the document sheet toward image reading means each mounted on the reading carriage,
wherein when the reading carriage is positioned in the second read portion, the apparatus is configured so that an angular attitude of the reflecting mirror is deflected by a predetermined angle or deflecting means disposed in the second read portion guides the reflected light to the reflecting mirror.

2. The image reading apparatus according to claim 1, wherein at least one reflecting mirror mounted on the reading carriage is axially supported rotatably by a carriage frame, and shift means for rotating the reflecting mirror is provided to deflect the angular attitude of the reflecting mirror by a predetermined angle.

3. The image reading apparatus according to claim 2, wherein the reflecting mirror supported rotatably is provided with biasing means for biasing rotation in one direction, and a position regulation stopper, and
the shift means is comprised of a regulation member for deflecting the attitude of the reflecting mirror rotatable against the biasing means.

4. The image reading apparatus according to claim 1, wherein in the apparatus housing is disposed deflecting means for guiding the reflected light of the document sheet moving in the second read portion to a predetermined direction, and
the deflecting means is configured to guide the reflected light of the document sheet to the reflecting mirror of the reading carriage positioned in the second read portion.

5. The image reading apparatus according to claim 1, wherein the light source lamp for applying light to the document sheet in the first read portion and to the document sheet in the second read portion is provided with one of light amount adjusting means, the light amount adjusting means including
(1) light amount adjusting means for adjusting a level of power to supply to the light source lamp mounted on the reading carriage,
(2) light amount adjusting means for selectively lighting at least two, first and second, light source lamps mounted on the reading carriage, and
(3) light amount adjusting means for concurrently lighting at least two, first and second, light source lamps or lighting one of the lamps, and
irradiates the document sheet in the first read portion and the document sheet in the second read portion with light of respective different light amounts.

6. The image reading apparatus according to claim 1, wherein the second read portion is provided with a document feeding unit for feeding a document sheet, and
the document feeding unit has a curved feed path for feeding a document sheet to the second read portion in a curved path, and a straight feed path for feeding a document sheet in a linear path.

7. The image reading apparatus according to claim 1, wherein in the apparatus housing are disposed a condenser lens for condensing the reflected light sent from the reading carriage, and the image reading means for performing photoelectric conversion on the light from the condenser lens.
